(19) United States
(12) Patent Application Publication
(10) Pub. No.: US 2024/0246572 A1
(43) Pub. Date: Jul. 25, 2024

(54) CONSUMER SERVICES IN AUTONOMOUS VEHICLES

(71) Applicant: Kyndryl, Inc., New York, NY (US)

(72) Inventors: Sarbajit K. RAKSHIT, Kolkata (IN); Laxmikantha Sai NANDURU, SECUNDERABAD (IN); Pritpal S. ARORA, Bangalore (IN)

(21) Appl. No.: 18/099,641

(22) Filed: Jan. 20, 2023

(51) Int. Cl. B60W 60/00; B60W 40/06; H04W 4/40

(52) U.S. Cl. CPC B60W 60/0025; B60W 40/06; H04W 4/40; B60W 2556/45; B60W 2756/10

(57) ABSTRACT

A computer-implemented method includes: advertising, by a computing device, at least one service including information from a learned knowledge base by a service provider vehicle within an autonomous vehicle ecosystem; connecting, by the computing device, the service provider vehicle to a service consumer vehicle within the autonomous vehicle ecosystem through a communication network; and sharing, by the computing device, the at least one service including the information from the learned knowledge base through a connection between the service provider vehicle and the service consumer vehicle using the communication network.

### BACKGROUND

Aspects of the present invention relate generally to a system and method for providing and consuming services in an autonomous connected vehicle ecosystem and, more particularly, to a system and method for autonomous vehicles sharing services based on the learning and knowledge which the autonomous vehicles have gained and harvested from their experiences in a terrain or a geographic territory.

In vehicles which operate autonomously, a vehicle may navigate to various locations using on-board sensors, which allow a vehicle to travel with minimal human interaction and/or without passengers. Therefore, an autonomous vehicle may allow occupants an opportunity to do other tasks while the autonomous vehicle drives itself.

### SUMMARY

In a first aspect of the invention, there is a computer-implemented method including: advertising, by a computing device, at least one service including information from a learned knowledge base by a service provider vehicle within an autonomous vehicle ecosystem; connecting, by the computing device, the service provider vehicle to a service consumer vehicle within the autonomous vehicle ecosystem through a communication network; and sharing, by the computing device, the at least one service including the information from the learned knowledge base through a connection between the service provider vehicle and the service consumer vehicle using the communication network.

In another aspect of the invention, there is a computer program product including one or more computer readable storage media having program instructions collectively stored on the one or more computer readable storage media. The program instructions are executable to: request by a consumer vehicle within an autonomous vehicle ecosystem through a communication network at least one service from a service vehicle within the autonomous vehicle ecosystem; connect the consumer vehicle with the service vehicle that is capable of providing the at least one service within the autonomous vehicle ecosystem; and receive the at least one service from the service vehicle.

In another aspect of the invention, there is system including a processor, a computer readable memory, one or more computer readable storage media, and program instructions collectively stored on the one or more computer readable storage media. The program instructions are executable to: advertise at least one service including information from a learned knowledge base by a service vehicle within an autonomous vehicle ecosystem; connection the service vehicle to a consumer vehicle within the autonomous vehicle ecosystem through a communication network; and share the at least one service including the information from the learned knowledge base through a connection between the consumer vehicle and the service vehicle using the communication network.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a diagram of an autonomous vehicle ecosystem in accordance with aspects of the invention.

FIG. 5 shows a flowchart for the autonomous vehicle ecosystem in accordance with aspects of the invention.

FIGS. 6-11 show schematic diagrams that depict network connectivity in an autonomous vehicle ecosystem according to embodiments of the present invention.

### DETAILED DESCRIPTION

Aspects of the present invention relate generally to a system and method for providing consumer services in an autonomous connected vehicle ecosystem and, more particularly, to a system and method for sharing services in an autonomous vehicles ecosystem using a knowledge base learned from the autonomous vehicles. The knowledge base may include many different information include experiences in a terrain or a geographic territory, as examples. In embodiments, the systems and methods described herein rely on an autonomous connected vehicle ecosystem in which at least one vehicle is designated as a consumer which polls and discovers available services from other vehicles designated as service providers which can perform activities in a synchronous and simultaneous manner for the mutual benefit of both the consumer and the service providers. Further, in an example, the systems and methods described herein create an ad-hoc network for communication with other vehicles within a predetermined vicinity.

Implementations of the invention provide an improvement in the technical field of an autonomous connected vehicle ecosystem by including vehicles which are configured to communicate with other vehicles within a predetermined distance to share information, such as road conditions, traffic condition, specifications, health status, available services, relative locations, acceptance of service requests, etc. In more specific embodiments, the information may include sharing of a knowledge base that has been learned by a service provider, e.g., road conditions, routes, etc. Implementations of the invention also provide additional improvements in the technical field of autonomous connected vehicle ecosystems including, determining relative distances between vehicles with location and/or cruising speed details, providing advertising services, providing consumer vehicle requirements for services, discovering and identifying multiple service vehicles within a predetermined distance which include services which satisfy the requirements of the consumer vehicle, enabling service vehicles to advertise and provide chargeable services, and consumer vehicles to contract for the free and chargeable services using a blockchain ledger in real-time, etc.

Aspects of the present invention include a system, method and computer program product which allows identifying service vehicles that can provide services to other consumer vehicles such that other consumer vehicles can consume the services. For example, the system, method, and computer program product allows for the service vehicle to provide services to the consumer vehicle when the service vehicle is within a predetermined proximity (i.e., predetermined distance) of the consumer vehicle, provides an adequate service capacity (i.e., sufficient network service communication), and includes a knowledge base to provide the services. Also, aspects of the present invention may include a communication mechanism in which the consumer vehicle is able to locate and request the needed service from a service provider in an ad-hoc network with multiple consumer and service vehicles within a predetermined vicinity (i.e., predetermined distance).

Aspects of the present invention also include a system, method, and computer program product to allow communication and sharing of services and a knowledge base between service vehicles and consumer vehicles so that the consumer vehicles are able to effectively handle challenges in a specific area. For example, by sharing services and the knowledge base between service vehicles and consumer vehicles, vehicles may avoid adverse weather conditions, difficult road conditions, accidents on the road, traffic jams, etc. Further, downstream consumer vehicles which travel towards areas in which these conditions exist become aware of such conditions so that the downstream consumer vehicles may avoid getting caught in adverse conditions, for example. In aspects of the present invention, the consumer vehicles and service vehicles may be autonomous vehicles which are connected using an ad-hoc communication network for providing services.

Aspects of the present invention may also include a method, system, and computer program product in which service providers may advertise and provide services to consumer vehicles. In embodiments, by implementing the system, method, and computer program product herein, the consumer vehicles may consume services seamlessly in an autonomous connected vehicle ecosystem. Accordingly, implementations of the invention provide an improvement (i.e., technical solution) to a problem arising in the technical field of autonomous connected vehicles. In addition, implementations of the invention provide an improvement (i.e., technical solution) to a problem arising in the technical field of autonomous connected vehicles by allowing service providers to provide services and a knowledge base to consumer vehicles such that the consumer vehicles may avoid challenging situations on the road such as weather conditions, difficult road conditions, accidents, traffic jams, etc.

According to an aspect of the invention, the system, method, and computer program product allows identifying service vehicles that may provide services to other consumer vehicles such that the other consumer vehicles can consume the services. For example, the computer-implemented method includes: advertising at least one service by a service vehicle within an autonomous vehicle ecosystem; connecting the service vehicle to a consumer vehicle within the autonomous vehicle ecosystem through a communication network; and sharing the at least one service through a connection between the service vehicle and the consumer vehicle using the communication network. In another example, the computer-implemented method includes: requesting at least one service by a consumer vehicle within an autonomous vehicle ecosystem; connecting the consumer vehicle with a service vehicle within the autonomous vehicle ecosystem through a communication network; and receiving the at least one service through a connection between the consumer vehicle and the service vehicle using the communication network.

It should be understood that, to the extent implementations of the invention collect, store, or employ personal information provided by, or obtained from, individuals (for example, health information), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

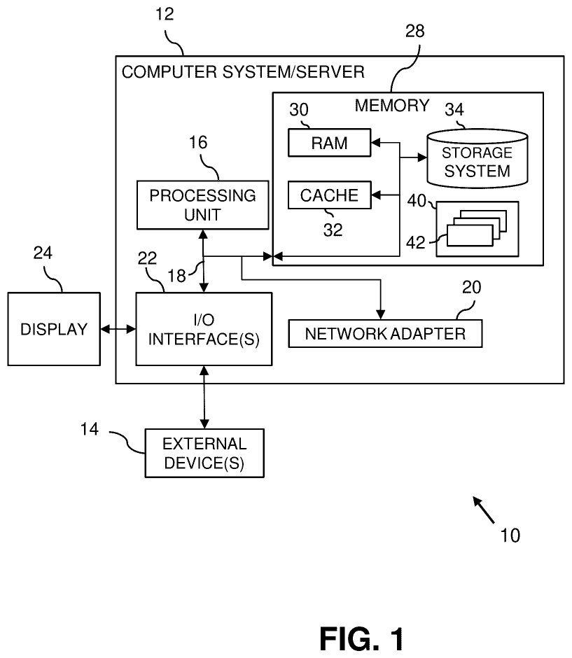

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

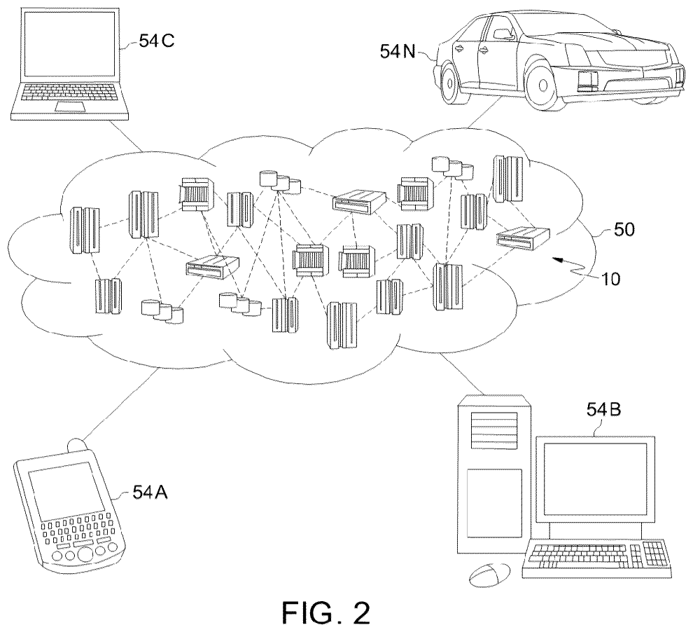

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

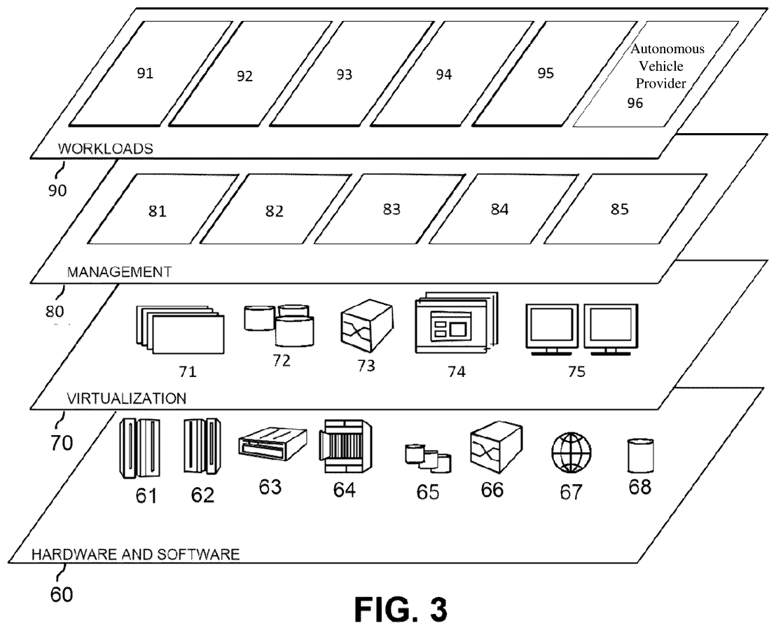

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and autonomous vehicle provider 96.

Implementations of the invention may include a computer system/server 12 of FIG. 1 in which one or more of the program modules 42 are configured to perform (or cause the computer system/server 12 to perform) one of more functions of the autonomous vehicle provider 96 of FIG. 3. For example, the one or more of the program modules 42 may be configured to advertise at least one service by a service vehicle within an autonomous vehicle ecosystem; connect the service vehicle to a consumer vehicle within the autonomous vehicle ecosystem through a communication network; and share the at least one service through a connection between the service vehicle and the consumer vehicle using the communication network.

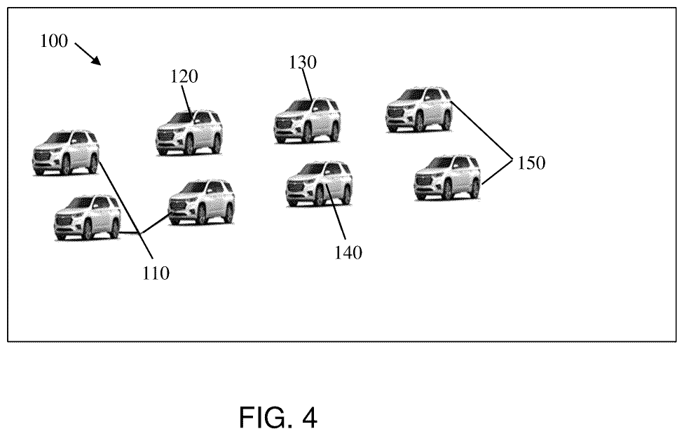

FIG. 4 shows a diagram of an autonomous vehicle ecosystem in accordance with aspects of the invention. In embodiments, the autonomous vehicle ecosystem 100 includes multiple autonomous vehicles 110, 120, 130, 140, and 150. In particular, the first set of autonomous vehicles 110 may be a plurality of service vehicles (i.e., service provider vehicles) in front of other autonomous vehicles 120, 130, 140, and 150 in the autonomous vehicle ecosystem 100. The first set of autonomous vehicles 110 may be service providers which become aware of and learn road conditions, traffic conditions, and terrain conditions, amongst other things, which may be consumed by the later arriving autonomous vehicles 120, 130, 140, and 150. In embodiments, the autonomous vehicles 120, 130, 140, and 150 (e.g., service consumer vehicles) may be looking for and/or requesting insights on road and traffic conditions.

It should also be recognized that any vehicle may learn information to obtain a knowledge base that can be shared with other vehicles. This knowledge base may include, amongst other things, road conditions, traffic conditions, preferred traffic routes, services, etc. In embodiments, a vehicle, e.g., autonomous vehicle 120, in back of another vehicle, e.g., autonomous vehicle 110, may seek a service or vice versa. That is, in the autonomous vehicle ecosystem 100 (e.g., the autonomous vehicles 110, 120, 130, 140, and 150), there may be many service providers that offer different services and a knowledge base (i.e., knowledge corpus) to other consumer vehicles. And each consumer vehicle will discover different services and make a determination as to which service to consume based on a set of requirements and/or criteria. Also, each service provider vehicle may determine which services will be made available to nearby consumer vehicles. Further, any of the autonomous vehicles 110, 120, 130, 140, and 150 may be both a consumer vehicle which consumes services and a service provider which provides services to other vehicles simultaneously. For example, the autonomous vehicle 120 may be a consumer vehicle with a flat tire or in need of some other service, which can be relayed to the autonomous vehicle 130 which has surplus spare parts, such as good tires, a spare battery, etc. In such a situation, the autonomous vehicle 130 becomes a service provider to assist the autonomous vehicle 120.

In embodiments, the autonomous vehicles 110, 120, 130, 140, and 150 may communicate with each other through one or more communication networks including, but not limited to, as a local area network (LAN), wide area network (WAN), global system for mobile communications (GSM), subscriber identification modules (SIMs), vehicle to vehicle (V2V) communications, near-field communications (NFC), satellite connectivity, the Internet, etc. In addition, the autonomous vehicles 110, 120, 130, 140, and 150 may be within a predetermined vicinity (i.e., predetermined distance) of each other to communicate effectively through the one or more communication networks in the autonomous vehicle ecosystem. In embodiments, a consumer vehicle may connect or disconnect from certain vehicles traveling outside or within a predetermined vicinity (i.e., predetermined distance) from a vehicle and may connect with other vehicles traveling into the predetermined vicinity (i.e., predetermined distance).

In FIG. 4, the autonomous vehicles 110, 120, 130, 140, and 150 may share information regarding any knowledge base, e.g., (i) vehicle specifications (e.g., manufacturer, make, model, engine type, configuration mileage of the vehicle, etc.), (ii) health status (e.g., battery charge level, fuel capacity, tire pressure, etc.), (iii) available services (e.g., storage capacity, network bandwidth, surplus fuel, battery charge, surplus vehicle spare parts, edge computing capacity, audio-visual entertainment, first aid lifesaving kits, a knowledge base—road history, weather condition history, accident history, terrain history, current roadworks, suggested speed limits, driving mode history, autonomous vehicle services (e.g., movies, songs, videos, etc. from a library which comply with copyright laws), available vehicle spares. etc.), (iv) relative location (e.g., current location, cruising speed, etc.), and (v) whether the vehicle is accepting requests and/or servicing requests, amongst other information. In embodiments, the knowledge base is learned by the vehicle's own experience including, e.g., road conditions, traffic conditions, etc.

In an example of FIG. 4, multiple autonomous vehicles 150 (e.g., a plurality of consumer vehicles) may be looking for insights on road and traffic conditions ahead. Therefore, the multiple autonomous vehicles 150 may communicate with the multiple autonomous vehicles 110 (e.g., a plurality of service vehicles) through one or more communication networks described above to request insights on road and traffic conditions. After the request has been made through the one or more communication networks, the multiple autonomous vehicles 110 may send the road, terrain, and traffic conditions to the multiple autonomous vehicles 150 which have been learned (e.g., knowledge base) to ensure that the multiple autonomous vehicles 150 are aware of any adverse road, terrain, and/or traffic conditions ahead of time to allow for the multiple autonomous vehicles 150 to decide whether to divert to another path to avoid the adverse road, terrain, and/or traffic conditions or remain on the same course. The autonomous vehicles 110, 120, 130, 140, and 150 may also determine relative distances between each other with location and/or cruising speed details through handshake and information exchanged through the one or more communication networks described above.

Further, the consumer vehicles (e.g., autonomous vehicles 120, 130, and 150) may discover the service vehicles (e.g., autonomous vehicles 110 and 140) by identifying multiple service vehicles based on a spread, relative distance, and/or position. They may also indicate an intent to consume services of the multiple service vehicles through the one or more communication networks described above. In particular, the consumer vehicles (e.g., autonomous vehicles 120, 130, and 150) may analyze a maturity of a knowledge base of the service vehicles (e.g., autonomous vehicles 110 and 140) to handle various contextual situations and may determine whether any of the service vehicles (e.g., autonomous vehicles 110 and 140) provide the various consumer requirements. Alternatively, if the consumer vehicles (e.g., autonomous vehicles 120, 130, and 150) determine that none of the service vehicles (e.g., autonomous vehicles 110 and 140) have the knowledge base to handle any of their requirements, the consumer vehicles (e.g., autonomous vehicles 120, 130, and 150) may look for alternate service vehicles.

In another example, service vehicles (e.g., autonomous vehicles 110 and 140) may advertise their services and consumer vehicles (e.g., autonomous vehicles 120, 130, and 150) may advertise their consumer requirements. For example, the service vehicles (e.g., autonomous vehicles 110 and 140) may advertise their service charges and free services through the one or more communication networks described above. In particular, the service vehicles (e.g., autonomous vehicles 110 and 140) may contract their services with the consumer vehicle (e.g., autonomous vehicles 120, 130, and 150) using a blockchain ledger in real-time.

Additionally, with reference to FIG. 4, consumer vehicles (e.g., autonomous vehicles 120, 130, and 150) may identify nearby service vehicles (e.g., autonomous vehicles 110 and 140) based on a relative position of the service vehicles and specifications. Once the consumer vehicles (e.g., autonomous vehicles 120, 130, and 150) identify nearby service vehicles (e.g., autonomous vehicles 110 and 140) that satisfy the specifications and/or various needs of the consumer vehicles (e.g., autonomous vehicles 120, 130, and 150), the consumer vehicles (e.g., autonomous vehicles 120, 130, and 150) may request and consume the services of a nearby service vehicle (e.g., autonomous vehicles 110 and 140).

For example, the consumer vehicles (e.g., autonomous vehicles 120, 130, and 150) may consume services relating to edge computing capacity, knowledge of terrain and road conditions, traffic jam data, vehicle spares, etc. of the nearby service vehicle (e.g., autonomous vehicles 110 and 140). For edge computing needs, consumer vehicles of the autonomous vehicles 110, 120, 130, 140, and 150 may assess their processing needs and discover other service vehicles (i.e., service providers) with surplus edge computing processing capacity. In this way, the consumer vehicles can leverage capabilities of the autonomous vehicle ecosystem by requesting additional computing needs from the service vehicles in the autonomous vehicle ecosystem.

As another example of FIG. 4, a consumer vehicle (e.g., autonomous vehicles 120, 130, and 150) may need to offload (e.g., evacuate) its passengers. In this situation, the consumer vehicle (e.g., autonomous vehicles 120, 130, and 150) may identify a nearby service vehicle (e.g., autonomous vehicles 110 and 140) that is able and willing to take these passengers. Once the consumer vehicle (e.g., autonomous vehicles 120, 130, and 150) identifies the nearby service vehicle (e.g., autonomous vehicles 110 and 140) that is willing to take these passengers, the consumer vehicle (e.g., autonomous vehicles 120, 130, and 150) may communicate with the nearby service vehicle (e.g., autonomous vehicles 110 and 140) in order to offload these passengers to the nearby service vehicle (e.g., autonomous vehicles 110 and 140). For example, the consumer vehicle may travel towards the nearby service vehicle to offload the passengers. In another example, the nearby service vehicle may travel towards the consumer vehicle to offload the passengers.

Moreover, each of the autonomous vehicles 110, 120, 130, 140, and 150 may identify other nearby vehicles and their positions, distance, cruising speed, and/or directions relative to each other. Also, each of the autonomous vehicles 110, 120, 130, 140, and 150 may have their own knowledge base (i.e., knowledge corpus) to address various contextual situations and geographic information system (GIS) maps for the area they are driving through. This knowledge base may be learned over time from the vehicle's experience. Also, each of the autonomous vehicles 110, 120, 130, 140, and 150 may update their knowledge base and GIS maps to better serve their passengers (i.e., payload) using a knowledge base from other autonomous vehicles 110, 120, 130, 140, and 150 to avoid situations such as poor roads, bad weather, rough terrain, and other adverse road and/or vehicle conditions. Moreover, each of the autonomous vehicles 110, 120, 130, 140, and 150 search for service vehicles (i.e., service providers) which satisfy the consumer requirements.

In a further example, in the autonomous vehicle ecosystem 100 (e.g., the autonomous vehicles 110, 120, 130, 140, and 150 in FIG. 4), a consumer vehicle may consume diagnostic services from a service vehicle. In particular, the diagnostic services may help the consumer vehicle assess its health (i.e., whether any maintenance or car service needs to be done), may learn different options for dealing with any inadequate health status (e.g., low oil), and may follow up with actions for addressing the inadequate health status. In another example, if a vehicle of the autonomous vehicles 110, 120, 130, 140, and 150 needs a vehicle spare part (e.g., a tire), the vehicle can request and locate service vehicles that are capable and willing to provide the vehicle spare part (e.g., a tire).

Further, in embodiments of the autonomous vehicle ecosystem (e.g., the autonomous vehicles 110, 120, 130, 140, and 150 in FIG. 4), a consumer vehicle may determine that its passengers need to be evacuated. Then, the consumer vehicle may request a service from a service vehicle that is willing to take the evacuated passengers. After the consumer vehicle locates the service vehicle that is willing to take the evacuated passengers, the consumer vehicle may contract with the service vehicle and the passengers are transferred to the service vehicle.

In the autonomous vehicle ecosystem 100 (e.g., the autonomous vehicles 110, 120, 130, 140, and 150 in FIG. 4), a service vehicle may announce charges for chargeable services and consumer vehicles may decide whether to consume the chargeable services. Further, when requirements of the consumer vehicle and the service of the service vehicle match, a blockchain or similar technology-based solution will facilitate the transaction. Also, the vehicles in the autonomous vehicle ecosystem (e.g., the autonomous vehicles 110, 120, 130, 140, and 150 in FIG. 4) may be cars, but also may be trucks, recreational vehicles, etc.

Accordingly, in the autonomous vehicle ecosystem 100, each of the autonomous vehicles 110, 120, 130, 140, and 150 in a predetermined vicinity (i.e., predetermined distance) may uniquely identify themselves and advertise their specification, capabilities, and services. Further, the network connectivity and applications may incorporate data security standards to protect privacy and comply with applicable industry and government laws. Also, the autonomous vehicles 110, 120, 130, 140, and 150 may collaborate with each other and may share information and services with each other. In embodiments of the present disclosure, sharing information and services with each other may be implemented in a publisher-subscriber model.

Also, each of the autonomous vehicles 110, 120, 130, 140, and 150 may assess services which may be provided by other vehicles and determine if they want to consume the services. Alternatively, each of the autonomous vehicles 110, 120, 130, 140, and 150 may provide services in a specific context/scenario. For example, a vehicle of the autonomous vehicles 110, 120, 130, 140, and 150 that has a terrain history of an area might discover another vehicle that has just driven in the opposite direction and has the latest information of the road conditions. In this situation, the vehicle of the autonomous vehicles 110, 120, 130, 140, and 150 may consume services provided by another vehicle driving in the opposite direction and update their knowledge base.

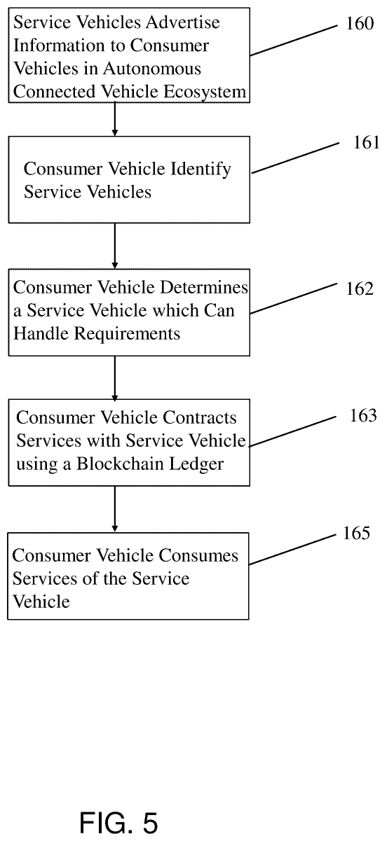

FIG. 5 shows a flowchart for the autonomous vehicle ecosystem in accordance with aspects of the invention. In FIG. 5, in step 160, service vehicles may learn information for their knowledge base (i.e., knowledge corpus) and may advertise their information to consumer vehicles in an autonomous connected vehicle ecosystem. In particular, the service vehicles may exchange and communicate data (e.g., information of their knowledge base) to consumer vehicles in the autonomous connected vehicle ecosystem through an electronic handshake. The consumer and service vehicles may also determine relative distances between each other with location and/or cruising speed details based on the electronic handshake and information exchanged. Further, service vehicles may advertise their services and consumer vehicles may indicate their requirements for services. In this way, consumer vehicles may discover service vehicles (e.g., request information for the knowledge base of service vehicles) by matching services of service providers with requirement for services of consumer vehicles.

In step 161, a consumer vehicle may identify service vehicles which may satisfy their requirements for services based on a spread, relative distance, and relative position of service vehicles within the autonomous vehicle ecosystem. Further, the consumer vehicle may indicate intent to consume services from identified service vehicles.

In step 162, the consumer vehicle may analyze a maturity of the knowledge base (i.e., knowledge corpus) of the identified service vehicles to determine a service vehicle which may be preferred to handle the requirements for services. The consumer vehicles may then decide to use the services of the determined service vehicle. Alternatively, the consumer vehicle may decide to look for an alternate service vehicle in the road ahead.

In step 163 (which may be an optional step), the consumer vehicle may contract with services of the determined service vehicle using a blockchain ledger or equivalent technology in real-time. In particular, the services of the determined service vehicle may include both free and chargeable services.

In step 165, the consumer vehicle will consume services. This may be based on, for example, the service vehicle being at a relative position, requirements, and/or specifications of the vehicles. In particular, the consumer vehicle may consume specific services of the determined service vehicles, such as knowledge of terrain and road conditions, traffic data, etc.

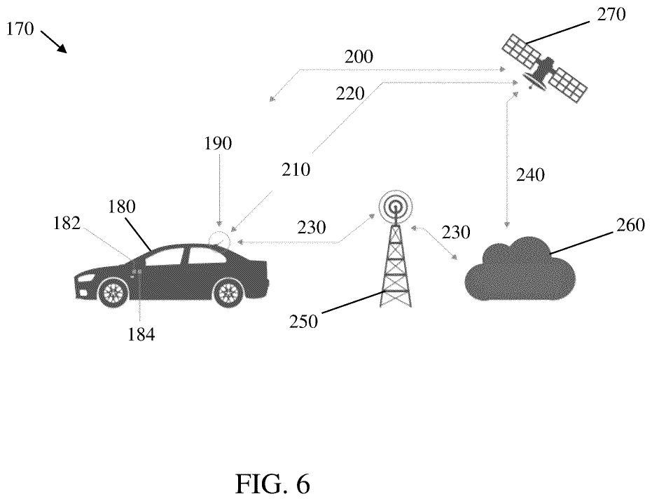

FIG. 6 shows a network connectivity system 170 which comprises a vehicle 180, a cell tower 250, a cloud computing environment 260 (similar to the cloud computing environment 50 in FIG. 2), and a satellite 270. In embodiments of the present disclosure, the vehicle 180 may be representative of any of the autonomous vehicles 110, 120, 130, 140, and 150 of FIG. 4, which may have a satellite communications module 182 for receiving broadcast data and sending acknowledgments. The satellite communications module 182 may comprise a chipset and software library. The vehicle 180 may also comprise a telematics control unit (TCU) 184 which manages communication and applies firmware updates to other electronics in the vehicle 180, including gateway functions, firewall, etc. The vehicle 180 may also comprise an antenna 190 for communicating to the satellite 270 using a broadcast/multicast signal 200.

In embodiments of the present disclosure, the antenna 190 may communicate to the satellite 270 using two-way short message/messaging service (SMS) 220 for sending and receiving predetermined data, such as software, firmware, navigation data, security patches, telemetry, etc. The antenna 190 may also communicate to the cell tower 250 using mobile communication standards 230, such as long-term evolution (LTE), Wi-Fi, and cellular data. The cell tower 250 may also communicate to the cloud computing environment 260 using mobile communication standards 230 (e.g., LTE, Wi-Fi, and cellular data). The satellite 270 may communicate to the cloud computing environment 260 using feeder links 240.

In an example, the vehicle 180 may be a consumer vehicle which communicates through the cell tower 250 and/or the satellite 270 to obtain information from service vehicles within a predetermined distance. This information may include, e.g., insights on road or traffic conditions, or other knowledge base.

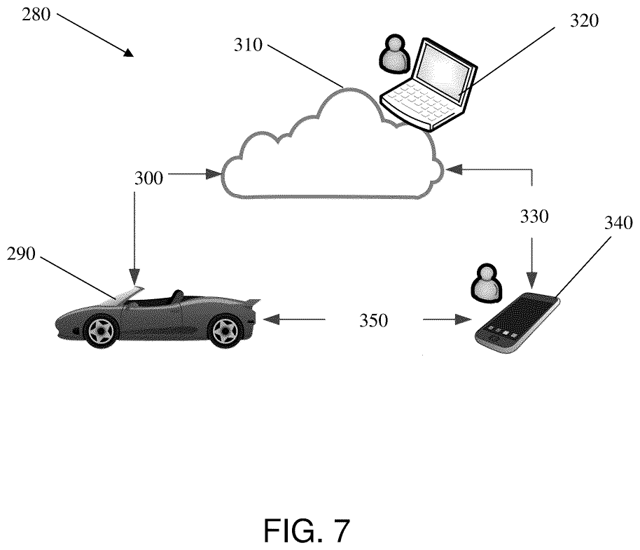

FIG. 7 shows a network connectivity system 280 which comprises a vehicle 290, the cloud computing environment 50, a user 320, and a vehicle owner device 340. In embodiments of the present disclosure, the vehicle 290 may be representative of any of the autonomous vehicles 110, 120, 130, 140, and 150 of FIG. 4, which may communicate with the cloud computing environment 310 using the global system for mobile communications (GSM) standard 300. The vehicle 290 may also communicate with the vehicle owner device 340 using other mobile communication standards 350, such as near-field communication (NFC), Wi-Fi, and Bluetooth. The vehicle owner device 340 may communicate with the cloud computing environment 310 using GSM and/or Wi-Fi standards 330.

In FIG. 7, the cloud computing environment 310 includes data from the user 320. Accordingly, the autonomous vehicles 110, 120, 130, 140, and 150 in FIG. 4 may communicate with each other using the second network connectivity system 280; although embodiments are not limited to this network connectivity system. In an example, the vehicle 290 may be a consumer vehicle which communicates through the cloud computing environment 310 with service vehicles within a predetermined distance which have insights on road and traffic conditions, or a knowledge base. In another example, the vehicle 290 may be a service vehicle which communicates through the cloud computing environment 310 for providing services, such as road and traffic conditions, spare parts, or the knowledge base to other consumer vehicles within the predetermined distance.

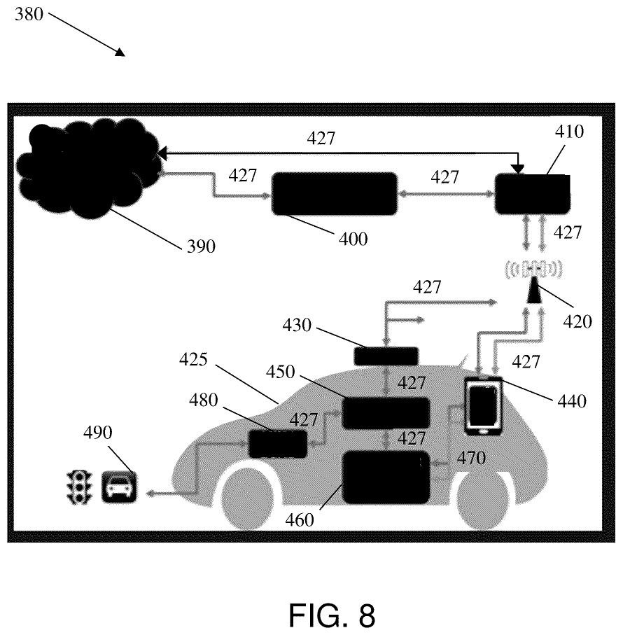

FIG. 8 shows a network connectivity system 380 which includes the cloud computing environment 50, a data center 400, a mobile network 410, a cell tower 420, a first vehicle 425, a mobile phone 440, and a second vehicle 490. In embodiments, the first vehicle 425 comprises an antenna 430, an embedded modem 450, an infotainment and user interaction system 460, a vehicle-to-everything (V2X) and dedicated short range communications (DSRC) module 480.

In FIG. 8, the cloud computing environment 390 may communicate with the mobile network 410 through a mobile communication standard 427, such as LTE, 3rd generation of wireless technology (3G), fourth generation of wireless technology (4G), etc. In addition, the cloud computing environment 390 may communicate with the data center 400 through the mobile communication standard 427 (e.g., LTE, 3G, 4G, etc.) The data center 400 may also communicate with the mobile network 410 through the mobile network communication standard 427 (e.g., LTE, 3G, 4G, etc.). The mobile network 410 may also communicate with the cell tower 420 through the mobile network communication standard 427 (e.g., LTE, 3G, 4G, etc.).

In FIG. 8, the cell tower 420 may communicate with applications on the mobile phone 440 through the mobile communication standard 427 (e.g., LTE, 3G, 4G, etc.). The cell tower 420 may also communicate with an antenna 430 of the first vehicles 420 through the mobile communication standard 427 (e.g., LTE, 3G, 4G, etc.). The mobile phone 440 may communicate with the infotainment and user interaction system 460 through a wireless communication standard 470, such as Wi-Fi, Bluetooth, etc. The antenna 430 may communicate with the embedded modem 450 through the mobile communication standard 427 (e.g., LTE, 3G, 4G, etc.). The embedded modem 450 may also communicate with the infotainment and user interaction system 460 and the V2X and DSRC module 480 through the mobile communication standard 427 (e.g., LTE, 3G, 4G, etc.). The V2X and DSRC module 480 may communicate with the second vehicle 490 through the V2X and DSRC wireless communication standards. Accordingly, the autonomous vehicles 110, 120, 130, 140, and 150 in FIG. 4 may communicate with each other using the third network connectivity system 280. In an example, the first vehicle 425 may be a consumer vehicle which communicates through the V2X and DSRC module 480 with the second vehicle 490 which has insights on road and traffic conditions.

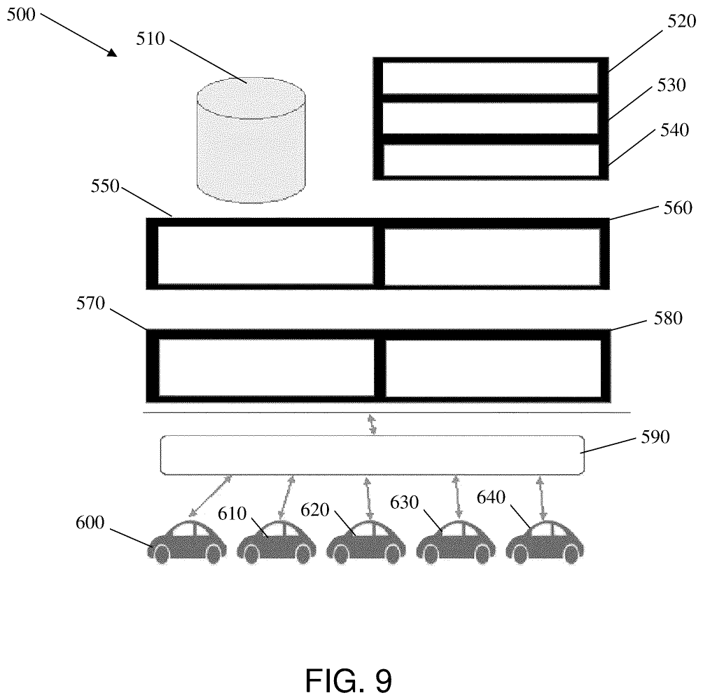

FIG. 9 shows a network connectivity system 500 which includes a database 510, a visualization layer 520, a workflow 530, analytics 540, data integration 550, data security 560, a machine to machine broker 570, a machine to machine subscriber 580, Internet of things (IOT) gateway 590, and a plurality of vehicles 600, 610, 620, 630, and 640. In FIG. 9, the vehicles 600, 610, 620, 630, and 640 may send data to the IOT gateway 590 via wireless communication standards, such as Wi-Fi, 3G, 4G, LTE, etc. The IOT gateway 590 may send the data from the vehicles 600, 610, 620, 630, and 640 to the machine to machine broker 570 through a cloud environment. In an example of the present disclosure, the machine to machine broker 570 may comprise a Mosquito broker which is used as a publisher. In particular, the machine to machine broker 570, upon receiving the data from the vehicles 600, 610, 620, 630, and 640 may publish the data to the machine to machine subscriber 580. In an example of the present disclosure, the machine to machine subscriber 580 may also be a Mosquito subscriber.

In FIG. 9, the machine to machine subscriber 580 may send the data through data integration 550 and data security 560 before being used in the analytics 540, the workflow 530, and the visualization layer 520. Additionally, the machine to machine subscriber 580 may also send the data to the database 510 for storing the data. In an example of the present disclosure, the database 510 may be a relational database such as relational database management system (RDBMS) or a distributed database such as a non-structured query language (NoSQL). In FIG. 9, the fourth network connectivity system 500 may be an example of a publisher-subscriber model for the autonomous vehicles 110, 120, 130, 140, and 150 in FIG. 4. However, embodiments of the autonomous vehicles 110, 120, 130, 140, and 150 in FIG. 4 are not limited to this network connectivity system. In an example, one of the vehicles 600, 610, 620, 630, and 640 may be a consumer vehicle which communicates through the IOT gateway 590 with service vehicles to gain insights on road and traffic conditions, spare parts, or a knowledge base.

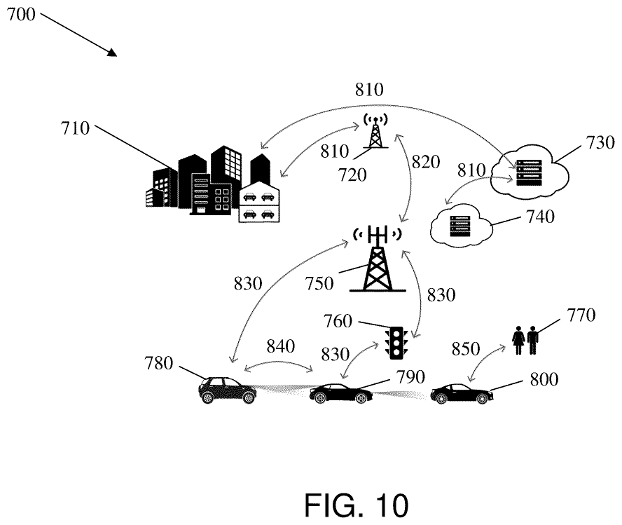

FIG. 10 shows a network connectivity system 700 which includes a smart city 710, a small cell tower 720, a central data center 730, an edge data center 740, a macro cell tower 750, a traffic light 760, users 770, and a plurality of vehicles 780, 790, and 800. In FIG. 10, the smart city 710 may communicate with the small cell tower 720 and the central data center 730 through a Narrowband Internet of things (NB-IOT) wireless technology 810. In embodiments of the present disclosure, the small cell tower 720 may communicate with the macro cell tower 750 through a wireless standard 820, such as LTE, 5G, etc. The central data center 730 may communicate with an edge data center 740 through the NB-IOT wireless technology 810.

In FIG. 10, the macro cell tower 750 may communicate with the traffic light 760 and the vehicle 780 through a vehicle-to-infrastructure (V2I) standard 830. The traffic light 760 may also communicate with the vehicle 790 through the V2I standard 830. The vehicle 780 may communicate with the vehicle 790 through a vehicle-to-vehicle (V2V) standard 840. The vehicle 800 may communicate with the users 770 (e.g., a mobile phone of one of the users 770) through a vehicle-to-pedestrian (V2P) standard 850. Accordingly, the autonomous vehicles 110, 120, 130, 140, and 150 in FIG. 4 may communicate with each other using the fifth network connectivity system 700; although embodiments are not limited to this network connectivity system. In an example, one of the vehicles 780, 790, and 800 may be a consumer vehicle which communicates through the V2V standard 840 with service vehicles having insights on road and traffic conditions, etc.

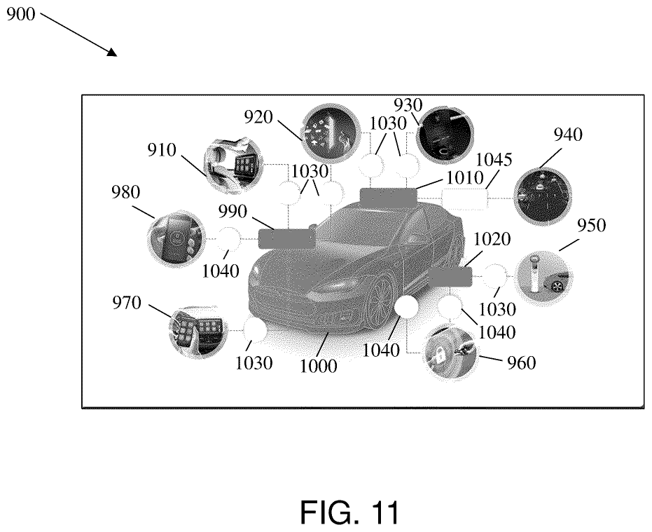

FIG. 11 shows a network connectivity system 900 which includes a vehicle 1000 which includes a multimedia distribution rear-seat entertainment module 910, Internet access module 920, LTE offload media services over the air (OTA) update 930, car2car and car2infrastructure 940, electric vehicle (EV) wireless charging infrastructure 950, a keyless entry, automated parking, tire pressure monitoring, and remote sensors control module 960, a display sharing, apple car play, android auto, MirrorLink module 970, hands free voice and music streaming module 980, infotainment module 990, telematics 1010, and body 1020. The keyless entry, automated parking, tire pressure monitoring, and remote sensors control module 960 may communicate with the body 1020 of the vehicle 1000 and other portions of the vehicle 1000 (e.g., the tire) through Bluetooth 1040. In addition, the hands free voice and music streaming module 980 may communicate with the infotainment module 990 through Bluetooth 1040. The car2car and car2infrastructure 940 may communicate with the telematics 1010 through at least one of Bluetooth or Institute of Electrical and Electronics Engineers (IEEE) 802.11p standards 1045. Although FIG. 11 shows the vehicle 1000 communicating with internal modules and devices, the vehicle 1000 may also communicate with other vehicles through different wireless standards, such as Wi-Fi, Bluetooth, and IEEE 802.11p.

In FIG. 11, the EV wireless charging infrastructure 950 may communicate with the body 1020 of the vehicle 1000 through Wi-Fi 1030. The LTE offload media services OTA update 930 and the Internet access module 920 may also communicate with the telematics 1010 through Wi-Fi 1030 also. In addition, the Internet access module 920 may provide Internet access to the entire vehicle 1000 through Wi-Fi 1030. The multimedia distribution rear-set entertainment module 910 may communicate with the infotainment module 990 through Wi-Fi 1030. Lastly, the display sharing, apple car play, android auto, MirrorLink module 970 may communicate with the infotainment module 990 through Wi-Fi 1030.

In embodiments of the present disclosure, each of the multimedia distribution rear-seat entertainment module 910, Internet access module 920, LTE offload media services over the air (OTA) update 930, car2car and car2infrastructure 940, electric vehicle (EV) wireless charging infrastructure 950, a keyless entry, automated parking, tire pressure monitoring, and remote sensors control module 960, a display sharing, apple car play, android auto, MirrorLink module 970, hands free voice and music streaming module 980, infotainment module 990, telematics 1010, and body 1020 may comprise a processor and/or firmware for performing their respective functions of the vehicle 1000 and for communicating with other modules of the vehicle 1000 and other vehicles in an autonomous vehicle ecosystem. Further, the autonomous vehicles 110, 120, 130, 140, and 150 in FIG. 4 may communicate with each other using the sixth network connectivity system 900; although embodiments are not limited to this network connectivity system. In an example, the vehicle 1000 may be a consumer vehicle which communicates through the Wi-Fi 1030 with service vehicles to gain insights on road and traffic conditions, spare parts, or a knowledge base, etc.

In embodiments, a service provider could offer to perform the processes described herein. In this case, the service provider can create, maintain, deploy, support, etc., the computer infrastructure that performs the process steps of the invention for one or more customers. These customers may be, for example, a business that tracks worker safety and provides health remediation to improve worker safety. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
advertising, by a computing device, at least one service including information from a learned knowledge base by a service provider vehicle within an autonomous vehicle ecosystem;
connecting, by the computing device, the service provider vehicle to a service consumer vehicle within the autonomous vehicle ecosystem through a communication network; and
sharing, by the computing device, the at least one service including the information from the learned knowledge base through a connection between the service provider vehicle and the service consumer vehicle using the communication network.

2. The method of claim 1, wherein the communication network is a wireless network which connects the service provider vehicle to the service consumer vehicle.

3. The method of claim 2, wherein the wireless network comprises Wi-Fi.

4. The method of claim 1, wherein the service provider vehicle is within a predetermined distance from the service consumer vehicle within the autonomous vehicle system.

5. The method of claim 1, wherein the information from the learned knowledge base comprises information about a geographic territory which the service consumer vehicle has not yet reached.

6. The method of claim 1, wherein the information from the learned knowledge base comprises edge computing processing capacity.

7. The method of claim 1, wherein the information from the learned knowledge base comprises road conditions.

8. The method of claim 7, wherein the road conditions comprise a portion of a road the consumer vehicle has not yet reached.

9. The method of claim 1, wherein the service consumer vehicle is different from the service provider vehicle.

10. The method of claim 1, wherein the sharing of the at least one service through the connection between the service provider vehicle and the service consumer vehicle further comprises contracting the at least one service between the service provider vehicle and the service consumer vehicle using a blockchain ledger in real-time.

11. The method of claim 1, wherein the service consumer vehicle and the service provider vehicle are autonomous vehicles within the autonomous vehicle ecosystem.

12. A computer program product comprising one or more computer readable storage media having program instructions collectively stored on the one or more computer readable storage media, the program instructions executable to:
request by a consumer vehicle within an autonomous vehicle ecosystem through a communication network at least one service from a service vehicle within the autonomous vehicle ecosystem;
connect the consumer vehicle with the service vehicle that is capable of providing the at least one service within the autonomous vehicle ecosystem; and
receive the at least one service from the service vehicle.

13. The computer program product of claim 12, wherein the communication network is a wireless network which connects the service vehicle to the consumer vehicle.

14. The computer program product of claim 12, wherein the at least one service includes information from a learned knowledge base.

15. The computer program product of claim 14, wherein the consumer vehicle is within a predetermined distance from the service vehicle within the autonomous vehicle system.

16. The computer program product of claim 14, wherein the information from the learned knowledge base comprises information about a geographic territory which the consumer vehicle has not yet reached.

17. The computer program product of claim 14, wherein the information from the learned knowledge base comprises edge computing processing capacity.

18. The computer program product of claim 14, wherein the information from the learned knowledge base comprises road conditions.

19. The computer program product of claim 12, wherein the receiving of the at least one service through the connection between the consumer vehicle and the service vehicle further comprises contracting the at least one service between the consumer vehicle and the service vehicle using a blockchain ledger in real-time, and the at least one service includes at least one of a spare part and a passenger.

20. A system comprising:
a processor, a computer readable memory, one or more computer readable storage media, and program instructions collectively stored on the one or more computer readable storage media, the program instructions executable to:
advertise at least one service including information from a learned knowledge base by a service vehicle within an autonomous vehicle ecosystem;
connect the service vehicle to a consumer vehicle within the autonomous vehicle ecosystem through a communication network; and
share the at least one service including the information from the learned knowledge base through a connection between the consumer vehicle and the service vehicle using the communication network.
